(19) United States
(12) Patent Application Publication
(10) Pub. No.: US 2010/0221399 A1
(43) Pub. Date: Sep. 2, 2010

(54) Method and Apparatus for manufacturing Graphic Art Chocolate

(76) Inventor: Jong Kim, Los Angeles, CA (US)

Correspondence Address: Jong K. Kim, 3310 W. Adams Blvd. 201, Los Angeles, CA, 90018, US

(21) Appl. No.: 12/394,325

(22) Filed: Feb. 27, 2009

(51) Int. Cl. A23G 3/50

(52) U.S. Cl. 426/383

(57) ABSTRACT

This invention is a method for manufacturing Graphic Art Chocolate what is designed drawings and/or photographic, letters, and printed through a edible transfer sheet using various color of chocolate ink or edible ink, using an apparatus for folding Graphic Art Chocolates and a new system of Both Side Mold.

And transfer sheets are putting above the both side flat surface, put a edible transfer sheet, and puts Spread thin layer of white chocolate. And lock the both side mold after closing. And put more chocolate to the hole. They are taking on the refrigerator about 3-5 minutes, and after take out from refrigerator, the chocolate stiffen board away from the mold. Then the figure is transferred to the chocolate stiffens board.

### BACKGROUND OF THE INVENTION

According to the European chocolate companies, they made with Silk Printer that printed on the transfer sheet. And the transfer sheet used next three methods.

1) First Method; Prints on Chocolate
Put the transfer sheet on a flat surface, printed surface up
Pour chocolate on the transfer sheet
Wait until the chocolate stiffens
Peel off the transfer sheet

Result; the design is printed on the chocolate.

Application; Break now the printed chocolate slab and place around or on top of cakes.

2) Second Method; Prints on Parlines.
When the chocolates are coming out of the enrobing machine on the conveyer belt, place the transfer sheet on top of them with the printed surface down, before the chocolate has the time to stiffen.
Wait until the chocolate stiffens.
Peel of the transfer sheet.

3) Third Method; Transfers with a Stencil.
Place the stencil on top of the transfer sheet.
Pour chocolate to fill the holes in the stencil
Let the chocolate stiffen on the transfer sheet.
Peel off the transfer sheet.

They are using printed chocolate slabs for decorate, place around or on top of cakes. Everybody makes printed chocolates for decoration or accessory, place around or on top of cakes.

Mean while in America, Edible Printing Systems came up with edible ink cartridges, edible icing sheets (Sugar sheets) for decorate on top of cakes. Method; uses computer, scanner and printer (using edible cartridge inks and edible icing sheets) that will allow create customized images, photos or art work and printing.

Result; the design is printed on the Edible icing sheet.

Application; the Edible icing sheet printed design put on the top of cakes.

### DESCRIPTION

### SUMMARY OF THE INVENTION

The present invention is directed to a method for Graphic Art chocolate. First of all, mast is using both side molds. At the both side flat surface, put a edible transfer sheet designed with edible ink drawings and/or photographic, letters. And puts Spread thin layer of chocolate. And lock the both side mold after closing. And put more chocolate to the hole. They are putting on the refrigerator about 3-5 minutes, and after put out from refrigerator, and pull out from the mold. This is two pages chocolate.

And now, let's make 4 pages chocolate card by two chocolates through connected apparatus Mariposa.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiment(s) which are presently preferred. It should be understood, however, that the invention is not limited to the precise arrangements and instrumentalities shown. In the drawings:

FIG. 1 is a schematic representation of a Art chocolate mold; The Art chocolate has to use both side mold.

FIG. 2 is a schematic representation of the process of the invention;

FIG. 3 is a view of a apparatus named Mariposa for couple two chocolate bars and for folding them.

FIG. 4 is a view of a two chocolates printed.

FIG. 5 is two chocolate bars (FIG. 4) united by apparatus Mariposa view of the apparatus shown in FIG. 3; the figure show pretty opened.

FIG. 6 is two chocolate bars (FIG. 4) united by apparatus Mariposa view of the apparatus shown in FIG. 3; the figure show pretty closed.

FIG. 7 is two chocolate bars (FIG. 4) united by apparatus Mariposa view of the apparatus shown in FIG. 3; the figure show half opened.

### DETAILED DESCRIPTION OF THE INVENTION

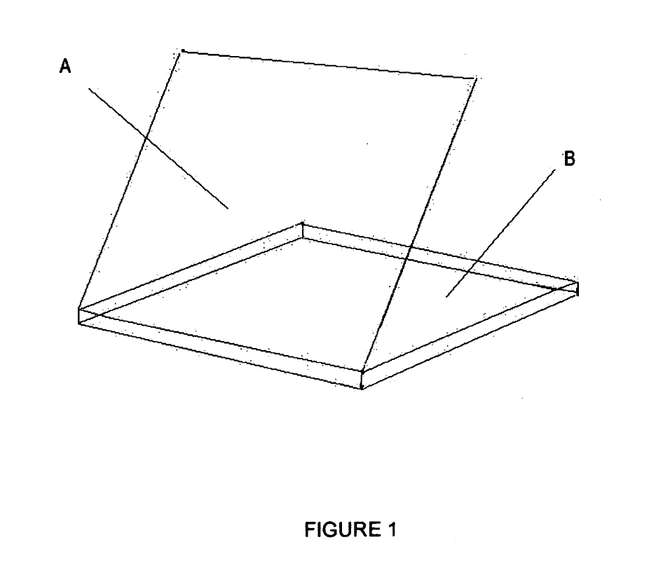

In accordance with FIG. 1 is a schematic representation of an Art chocolate mold; The Art chocolate has to use both side molds.

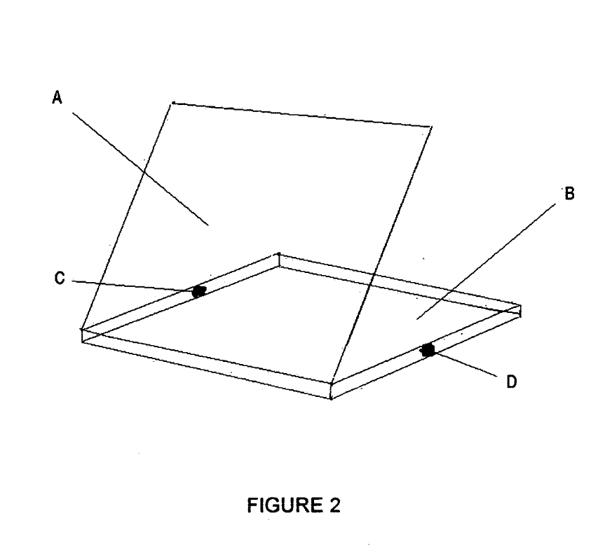

In accordance with FIG. 2 is a Icing sheet designed from the Edible printing systems, put on the one bottom side mold (A) and pour chocolate on the bottom side mold (A) and the other Transfer sheet put on the other upside mold (B) and pour chocolate on the upside mold(B). And lock the both side mold after closing(c). And put more chocolate to the hole (D). They are putting on the refrigerator about 3-5 minutes, and after put out from refrigerator, and pull out from the both side mold.

The result is; the design is printed on the both side of chocolate bar.

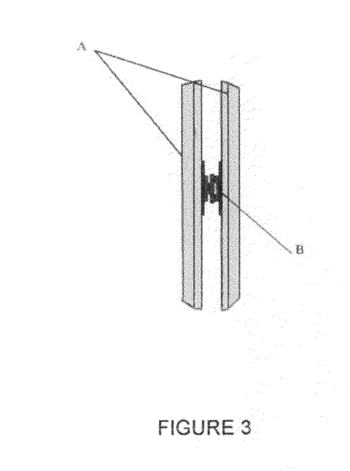

FIG. 3, is apparatus Mariposa made by two holders and a hinge.

The holder made by triangle plastic and two holders are holding each chocolate board or bar (A).

In the middle of holders, is a hinge for folding Chocolate board or bar(B).

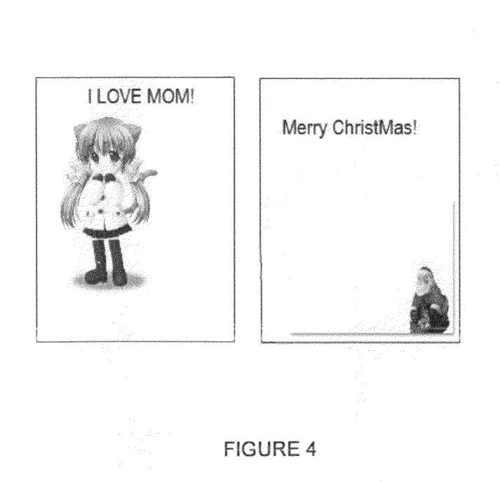

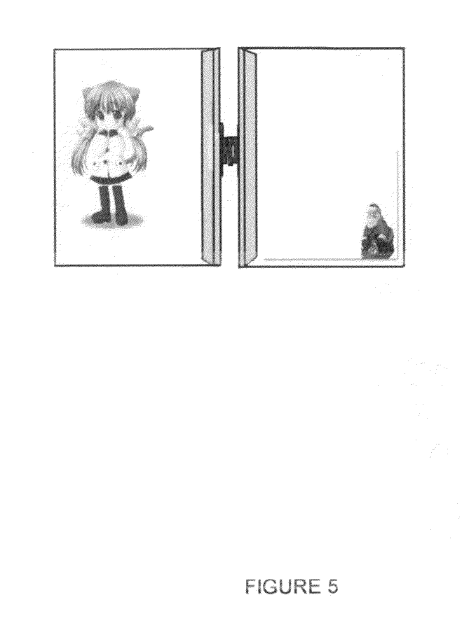

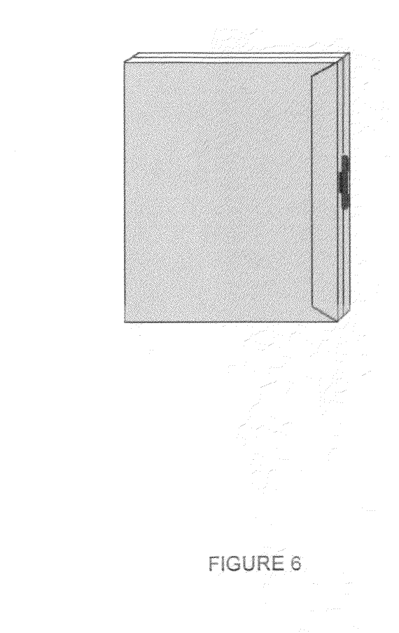

FIG. 4 is a view of a two chocolates printed FIG. 5 is two chocolate bars (FIG. 4) united by apparatus Mariposa view of the apparatus shown in FIG. 3; The figure show pretty opened. FIG. 6 is two chocolate bars (FIG. 4) united by apparatus Mariposa view of the apparatus shown in FIG. 3; the figure show pretty closed.

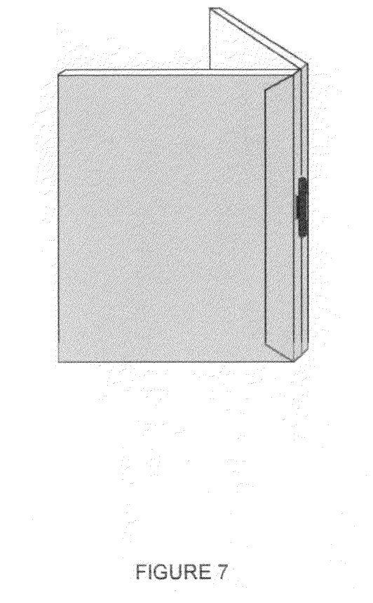

FIG. 7 is two chocolate bars (FIG. 4) united by apparatus Mariposa view of the apparatus shown in FIG. 3; the figure show harp opened.

What is claimed is:

1. This invention is a method for manufacturing Graphic Art Chocolate card what is designed drawings and/or photographic, letters, and printed through a edible transfer sheet using various color of chocolate ink or edible inks, also using an apparatus Mariposa for folding Graphic Art Chocolates and a new system of Both Side Mold.

2. The process according to claim 1, a method for manufacturing Art Chocolate card what is designed drawings and/or photographic, letters, and printed through a edible transfer sheet and figure of transfer sheet is transferred to the chocolate board or bar that will product as invitation cards or thank you cards for friends or couples and family.

3. The process according to claim 1, wherein the product as invitation cards or thank you cards for Christmas day, Valentine's day, white day, Mother's day, Ester day, Birthday, Anniversary day, Holy day season, Wedding day, graduated season, Engagement day, or/and for Advertising impact chocolate board or/and for Promotion Chocolate or Event Chocolate printed company logo or trademark or Brand Company at chocolate bar or board. Etc.
